(19) United States
(12) Patent Application Publication
(10) Pub. No.: US 2023/0087817 A1
(43) Pub. Date: Mar. 23, 2023

(54) System and Methods for Educational and Psychological Modeling and Assessment

(71) Applicant: Duolingo, Inc., Pittsburgh, PA (US)

(72) Inventors: Burr Settles, Pittsburgh, PA (US); Kevin Yancey, Pittsburgh, PA (US); Geoffrey T. LaFlair, Pittsburgh, PA (US); Arya McCarthy, Baltimore, MD (US)

(21) Appl. No.: 17/947,459

(22) Filed: Sep. 19, 2022

Related U.S. Application Data
(60) Provisional application No. 63/246,125, filed on Sep. 20, 2021.

(51) Int. Cl. G09B 7/10; G09B 19/06; G09B 7/02

(52) U.S. Cl. CPC G09B 7/10; G09B 19/06; G09B 7/02

(57) ABSTRACT

Methods, apparatuses, and systems for more efficiently assessing the performance of a person on a test or at completing a task. The disclosure is directed to systems, apparatuses, and methods for training a model to jointly predict (a) test item annotations (e.g., a domain or subject-matter expert's assessment of the difficulty level of a test item) and (b) test-taker responses. The disclosed approach may be used to estimate item parameters used in tests for evaluating the proficiency of a test taker, and more specifically, as part of a language proficiency test or examination.

### CROSS REFERENCE TO RELATED APPLICATION

This application claims the benefit of U.S. Provisional Application No. 63/246,125, filed Sep. 20, 2021, and titled “ System and Methods for Educational and Psychological Modelling and Assessment”, the disclosure of which is incorporated in its entirety by this reference.

### BACKGROUND

Tests of various forms are often used to assess the proficiency of a test-taker with regards to a specific skill or to assess the knowledge they have acquired through study. However, most methodologies used in scoring a test rely on determining the number of “correct” responses. While this is helpful, it may not be fully reflective of a test-taker's ability, as some questions may be much more difficult than others or require specific skills that demonstrate greater ability on the part of the user (who may be a test taker or subject learner, as examples). Thus, the relative difficulty of a test item (i.e., a test question or task) and the skills it requires to complete may be important factors to consider when evaluating a person's performance.

Conventional educational and psychological modeling (with applications to both instruction (teaching) and assessment (testing)) rely on methods such as item response theory (IRT)¹ or knowledge tracing (KT)², along with pilot or operational test data to estimate item parameters (e.g., difficulty) and test-taker ability parameters. However, results obtained in this manner are often norm-referenced rather than criterion-referenced, meaning they are interpretable relative to the pilot or test-taking population rather than to the characteristics of the underlying construct. This may reduce the utility and/or validity of the interpretation of the test or item results, as it ignores the relative difficulty of an item when considering the test-taker's abilities and knowledge. ¹ In psychometrics, item response theory (IRT) (also known as latent trait theory, strong true score theory, or modern mental test theory) is a paradigm for the design, analysis, and scoring of tests, questionnaires, and similar instruments measuring abilities, attitudes, or other variables. it is a theory of testing based on the relationship between individuals' performances on a test item and the test takers' levels of performance on an overall measure of the ability that item was designed to measure. See Wikipedia entry for “Item Response Theory”.² Knowledge Tracing may be treated as a task of modelling student knowledge over time so one can accurately predict how students will perform on future interactions.

Previously, Settles et al. (2020)³ described a method that alleviates the need for pilot or operational data to create such models by using data labeled by subject matter or domain experts to train machine learning models for estimations of item difficulty. However, while an improvement, this approach is not an optimal solution. For example, once a test has been operationalized and significant observational item responses are available, the method described by Settles et al. cannot directly combine both expert-annotated data and the operational test data (i.e., the item responses collected during previous administrations of the test). This is a disadvantage, as without operational test data, the item difficulty estimates are less accurate than what can often be achieved with IRT methods. Furthermore, the method described in Settles et al. can only generate an estimate of item difficulty, and typically cannot be used to estimate item discrimination or other item parameters that may be relevant to modeling the relationship between test-taker ability and item responses. Finally, test scores derived from the Settles et al. method are inherently criterion-referenced based on a rubric) rather than norm-referenced (based on the test-taking population). ³ B. Settles, G. T. LaFlair, and M. Hagiwara. 2020. Machine Learning Driven Language Assessment. Transactions of the Association for Computational Linguistics, vol. 8, pp. 247-263, 2020.

Embodiments of the disclosure overcome these and other disadvantages of conventional approaches to evaluating the performance of a test-taker, both collectively and individually.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

In some embodiments, the disclosed system, apparatuses, and methods take into consideration both domain expert annotations and operational test data produced by actual test takers. In one embodiment, this is accomplished by using a “multi-task” machine learning (ML) approach that extends standard or conventional psychometric models. This results in a model that is both criterion-referenced and norm-referenced and yields more reliable results with stronger validity evidence than the conventional approaches can do independently.

In some embodiments, the disclosed system, apparatuses, and methods bridge a gap between the two conventional approaches mentioned (IRT and KT), by explaining or describing item parameters in terms of item features, which may be interpreted as, or linked to, sub-skills that test-takers may need to master in order to answer a test item correctly.

In some embodiments, the approach disclosed herein produces a model representing both (1) rubric or classification systems used by domain (subject matter) experts and (2) the psychometric properties that may be inferred from pilot or operational testing data. Thus, an important benefit of the described approach is that it enables joint use of both (1) expert-annotated data describing the construct of the educational or psychological domain being modeled or tested (facilitating criterion-referenced interpretations), and (2) empirical pilot or operational test item response data from the test-taking population (facilitating norm-referenced interpretations).

In some embodiments, the disclosed approach may provide a potential solution to the “cold start problem”, which occurs when initially only expert annotation data may be available. The disclosed approach may also provide a solution to the “fast start problem”, which occurs when operational data may be available but are limited, such as with computer-adaptive tests (CATs) where item exposure is controlled to maintain test security and integrity. In these situations, the disclosed model's item parameter estimates can gradually be refined and improved as pilot or operational data becomes available in a sufficient quantity.

The disclosed approach may also provide a solution to the “jump start problem”, which occurs when there are large amounts of operational data available for an existing set of test items, and one wishes to use that data to estimate parameters for new items for which little or no operational data is available. In this case, the disclosed approach may be used to generalize item parameter estimates for existing items to make more accurate estimates of item parameters for new items. The disclosed approach also provides a way to interpret the results in terms of both criterion-referenced (from expert data) and norm-referenced (from pilot/operational data) values. This may provide greater insight into a test taker's performance and abilities.

In some embodiments, the disclosure is directed to a method for more effectively assessing the performance of a person on a test or at completing a task. The method may include model design, parameter estimation, and exam administration phases, as examples. In one embodiment, the disclosed method may include the following steps, stages, or operations:
Defining a representation or model of test-taker proficiency, where the model definition process may comprise:
   Choosing (selecting or identifying) one or more proficiency parameters of a test-taker to measure in relation to a common scale, wherein the scale may be both criteria (or criterion) referenced and/or norm-referenced;
      In one embodiment, the test-taker proficiency parameter is an indication of the test-taker's proficiency or ability regarding a particular skill (such as reading comprehension);
      In some embodiments, more than a single test-taker proficiency parameter may be considered—in such an example, a test may measure multiple and possibly related proficiencies and incorporate a multi-dimensional IRT model;
Defining a representation or model for a test item, where the representation definition process may comprise:
   a Choosing (selecting or identifying) an Item Response Function (IRF), which is a function of test item parameters (item difficulty, discrimination, or chance, as examples), to model the probability of the test-taker providing a response to a test item corresponding to a particular grade, conditioned on (dependent upon) the test-taker's proficiency;
   Choosing a set of features to represent test items, each of which may be a value that is known or can be computed (extracted) for each test item; and
   Choosing an Item Parameter Feature Function (IPFF) for each test item parameter, where the IPFF deconstructs that item parameter into a function dependent on the previously specified test item features and includes one or more differentiable weights;
Training a Machine Learning Model (a form of test item parameter estimation), where the training process may comprise:
   Retrieving test-taker graded responses from multiple administrations of a test item or items;
   Retrieving available annotation data for test items (such as subject matter expert indications of the expected level of proficiency needed to correctly answer a test item, if available and applicable);
   Extracting one or more features for each test item;
      As one example, such a language-based transformer is BERT (Bidirectional Encoder Representations from Transformers) for text-based items;
   Representing the conditional probability of a particular graded response (a probability of a test-taker responding correctly, given a set of test item parameters and a test-taker proficiency level) by applying (evaluating) the Item Response Function (IRF) to (1) the item parameters obtained from applying the Item Parameter Feature Function (IPFF) to the item's features and (2) the test-taker's proficiency (their level of skill or ability);
   If applicable, mapping a criterion-referenced scale for which at least some items are annotated onto an applicable item parameter's scale:
      For example, the difficulty item parameter's logit scale may be mapped to the ordinal CEFR scale by segmenting the logit scale with “cutpoints” or breaks between each CEFR level that can be estimated in the following step using the CEFR annotations of some items;
   Estimating the Item Parameter Feature Function (IPFF) weights and test-taker proficiencies (the test taker level of skill) by applying statistical, machine learning, and/or optimization methods to the representations to maximize;
      the joint posterior probability of the observed test-taker graded responses, and
      the joint posterior probability of the item annotations (if applicable);
         in one sense, this serves to optimize Item Parameter Feature

Function (IPFF) weights to jointly predict a test-taker response to a test item and a subject-matter expert's evaluation of the test item difficulty;
Storing the resulting item parameter estimates, Item Parameter Feature Function (IPFF) weights, and (if applicable) scale “cutpoints” in a memory or data storage element;
Administering test items and evaluating a test-taker's responses, where the test administration process may comprise:
   Selecting one or more test-items, wherein the test item is a question to be answered or a task to be performed by a test-taker;
   Collecting and storing a test-taker's response(s) in a database;
   Grading the response(s) to indicate correctness or quality of the responses;
      for some item types, it may make sense to award partial credit for partially correct answers. In these cases, the grade may be a value from [0, 1], rather than a correct/incorrect grade;
   Representing the probability distribution of the test-taker's proficiency, given the test-taker's graded response(s), the corresponding item parameter estimates, the prior probability distribution, and the Item Response Function (IRF);
      This may be done by applying Bayes' Rule or another suitable technique;
   Converting that probability distribution into a proficiency estimate (e.g., by computing the expected-a-posteriori (EAP) measure of the distribution);
   Repeating the previous steps based on the new proficiency estimate until the testing process is completed;
      In one use case, the disclosed approach may be used to more efficiently and accurately determine a test taker's proficiency at a task;
         In one sense, this is accomplished by maximizing the accuracy of the estimates while minimizing the number of questions that need to be asked;
      In one use case, the disclosed approach may be used to evaluate the informativeness of a potential test item or predict the expected performance of a test-taker on that item; and
Interpreting the final proficiency estimate in terms of norm-reference or criterion-referenced scales.

In one embodiment, the disclosure is directed to a system for more effectively assessing the performance of a person on a test or at completing a task. The system may include a set of computer-executable instructions, a memory or data storage element (such as a non-transitory computer-readable medium) on (or in) which the instructions are stored, and one or more electronic processors or co-processors. When executed by the processors or co-processors, the instructions cause the processors or co-processors (or a device of which they are part) to perform a set of operations that implement an embodiment of the disclosed method or methods.

In one embodiment, the disclosure is directed to a non-transitory computer readable medium containing a set of computer-executable instructions, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed herein may provide services through a SaaS or multi-tenant platform. The platform provides access to multiple entities, each with a separate account and associated data storage. Each account may correspond to a user, a set of users, an entity, a set or category of entities, a set or category of users, a set or category of tests or tasks, an industry, or an organization, for example. Each account may access one or more services, a set of which are instantiated in their account, and which implement one or more of the methods or functions described herein.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and will be described in detail herein. However, the exemplary or specific embodiments are not intended to be limited to the forms disclosed. Rather, the present disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1(a) is a diagram illustrating elements or components and processes that may be incorporated in a system to perform Educational and Psychological Modeling and Assessment, in accordance with some embodiments;

FIG. 1(b) is a diagram illustrating a set of processes, operations, functions, elements, or components that may be part of a system used to implement an embodiment;

FIG. 1(c) is a diagram illustrating the primary processes, operations, or functions performed as part of implementing an embodiment;

FIG. 2 is a diagram illustrating elements or components that may be present in a computer device or system configured to implement a method, process, function, or operation in accordance with an embodiment of the system and methods disclosed herein; and

FIGS. 3-5 are diagrams illustrating a deployment of the system and methods described herein for Educational and Psychological Modeling and Assessment as a service or application provided through a Software-as-a-Service platform, in accordance with some embodiments.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter will be described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that this disclosure will satisfy the statutory requirements and convey the scope of the disclosure to those skilled in the art.

Among other forms, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by a suitable processing element or elements (such as a processor, microprocessor, co-processor, CPU, GPU, TPU, OPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user over a network (e.g., the Internet) through a transfer of instructions or an application that executes a set of instructions.

In some embodiments, the systems and methods disclosed herein may provide services to end users through a SaaS or multi-tenant platform. The platform provides access to multiple entities, each with a separate account and associated data storage. Each account may correspond to a user, a set of users, an entity, a set or category of entities, a set or category of users, a set or category of tests or tasks, an industry, or an organization, for example. Each account may access one or more services (such as applications or functionality), a set of which are instantiated in their account, and which implement one or more of the methods, process, operations, or functions disclosed herein.

In some embodiments, one or more of the operations, functions, processes, or methods disclosed herein may be implemented by a specialized form of hardware, such as a programmable gate array, application specific integrated circuit (ASIC), or the like. Note that an embodiment of the disclosed methods may be implemented in the form of an application, a sub-routine that is part of a larger application, a “plug-in”, an extension to the functionality of a data processing system or platform, or other suitable form. The following detailed description is, therefore, not to be taken in a limiting sense.

In some embodiments, the disclosure is directed to systems, apparatuses, and methods for training a model to jointly predict (a) test item annotations (e.g., a domain or subject-matter expert's assessment of the difficulty level of a test item) and (b) test-taker responses. The disclosed approach may be used to estimate item parameters used in tests for evaluating the proficiency of a test taker, and more specifically, as part of a language proficiency test or examination. As discussed, item parameters are often estimated through item-response theory (IRT) frameworks, where such an approach has the disadvantage of requiring extensive response data from test takers.

Embodiments overcome this disadvantage in at least two ways: 1) by adopting an explanatory IRT framework that estimates test item parameters in terms of item features, enabling representation sharing across items to reduce the amount of test-taker response data needed, and 2) by generalizing conventional IRT model estimation techniques into a supervised multi-learning model training framework that can leverage both test-taker responses and subject-matter expert annotations in the parameter estimation process. Among other advantages, the disclosed approach is an effective and practical solution to the cold start, fast start, and/or jump start problems common to test design.

In a broad sense, some embodiments incorporate one or more of the following aspects and provide corresponding advantages to test developers:
Being able to refine test item parameter (e.g., difficulty and discrimination) estimates based on both subject-matter expert annotations and test-taker response data;
   Difficulty is a common item parameter in IRT models. It is the level of proficiency required to have a 50% chance of responding to the item correctly;
   Discrimination is also a common item parameter in IRT models. It represents a measure of how well an item discriminates/distinguishes between high and low proficiency test takers. A high discrimination item means that one can be more confident that a test-taker who gets it correct has a proficiency higher than the item's difficulty and one who gets its wrong has a proficiency lower than that difficulty;
Using representation sharing (i.e., using test item parameter features) to reduce the amount of data needed and estimate parameters of novel test items without pilot data or without the amount of such data typically required; and
Use of a common logit scale for both item difficulty and human assessments of the item's criterion-referenced level, which allows a proficiency scale to be both norm-referenced and criterion-referenced.

Embodiments may comprise a trained, multi-task machine learning (ML) model that combines both supervised learning of test item parameters (by training the model on subject-matter expert-labeled data using a rubric or construct) and item response theory (by training the model on observational item response data). This combined approach allows the model to refine item parameter estimates by incorporating test-taker response data but does not require it to produce high-quality estimates, even for novel test items.

With regards to an Item Parameter Feature Function (IPFF), an embodiment may employ generalized linear models, neural networks, or other mathematical function dependent on item features and that includes one or more differentiable weights. The type of model or technique used may depend on the application conditions and on empirical performance of the different approaches (e.g., manual features vs. automatic identification using a NN). In simpler cases, the IPFF may be a linear function (i.e., a weighted sum of features) or a log-linear function (i.e., the log of a weighted sum of features).

With this general definition of an IPFF function, one can also implement some item parameters that are learned per-item as in conventional non-explanatory IRT models, and not based on item features. This can be accomplished by using one-hot encoding on items and including those in the item features. Similarly, one can implement item parameters that are learned as a shared parameter across an entire set of items, which may be accomplished by using an IPFF that ignores item features and includes a single learnable weight.

As described, in some embodiments, the constructed models) and training process may allow for direct comparison between item difficulty, test-taker proficiency, and a domain-specific framework (such as the Common European Framework of Reference for Languages (CEFR; Council of Europe, 2001)) on a common logit scale.⁴ ⁴ In statistics, the logit function or the log-odds is the logarithm of the odds; logit (p)=log (p/(1−p))=log(p)−log (1−p)=−log(1/(p−1)), where p is a probability. It is a function that creates a map of probability values from (0,1) to (−∞,+∞).

In some embodiments, the item features may include arbitrary, rich linguistic (or other domain-relevant) features such as counts, or embeddings generated from passage-based test items, Additionally, some forms of features may assist in the interpretation of test item parameters in terms of linguistic theories and provide evidence that supports interpretation of test scores. For example, for language tests, such a model may utilize passage or contextual word embeddings (such as those generated by an embodiment of ELMo, Embeddings from Language Models, or BERT, Bidirectional Encoder Representations from Transformers) that facilitate strong generalization for an item type and address the cold start, fast start, and jump start problems by reducing the pilot testing required to introduce new items. Furthermore, the item parameters derived from using some of the described techniques may correlate with lexica-grammatical features of passages or words that are known to correlate well with reading complexity.

Using such item parameters in test design and administration can provide evidence that supports the interpretation of a test-taker's attained language comprehension and related skills. In general, increased reading complexity correlates with increased difficulty estimated by the model. As such, test takers with patterns of correct answers to higher complexity items (and therefore higher difficulty items under the model) can be inferred to have a higher relative proficiency or ability.

In some embodiments, the disclosed approach extends a conventional Rasch IRT model⁵ in two ways. First, in contrast to the standard IRT model which uses a single parameter for each item to represent task or test item difficulty, embodiments of the disclosure deconstruct item difficulty (or other item-specific parameter) and represent it as an Item Parameter Feature Function (IPFF), which may take the form of a weighted sum of item features. Second, embodiments incorporate this extended Rasch model into an ordinal-logistic regression multi-task learning framework to generate a unified estimation of test item difficulty across CEFR-labeled data and test-taker response data. ⁵ A standard Rasch model is a special case of logistic regression with one parameter per student i (their proficiency αi, an element of R) and one parameter per test item j (its difficulty βj, an element of R): p(y=1 |i, j)=σ(αᵢ−βⱼ)|.

This formulation allows a test creator to take advantage of both ordinal labels of items (e.g., subject-matter expert annotation rubrics based on a proficiency standard) and dichotomous responses to those items (e.g., correct/incorrect test taker responses to individual test items). The disclosed approach may also take advantage of additional item annotation data: for example, combining test-taker responses with labels from multiple, related standards-based rubrics (e.g., both the CEFR and ACTFL or other language proficiency framework). These labeled items can be disjunct or overlapping in the training data; however, it is important that the annotated items share the same feature representation as the items in the test-taker response data.

In some embodiments, the disclosed approach uses a common underlying logit scale to fit two or more separate, but related data sets. For example (and without loss of generality), the multi-task approach disclosed herein allows both ordinal annotations from subject-matter experts and dichotomous responses from test takers to be used as part of a single unified model.

If other domain-relevant annotation data exists, it may be incorporated into an embodiment or implementation of the disclosed approach. Such auxiliary data might include domain or constructs of items, such as the subject matter, narrative style and purpose, or readability scores provided by experts, as non-limiting examples. These data and labels could provide additional signal(s) to the model in a multi-task framework, similarly to how the CEFR data can provide information to the task of predicting a user's likelihood of getting an item correct and vice-versa. The auxiliary data could be incorporated either as features of a test item, (if the auxiliary data is known for all items) or as an entirely separate prediction task (e.g., given an item, predict its readability score as estimated by 3 experts). As an example, one could use input texts that are known to exhibit “beginner” instead of “advanced” language for training a language testing embodiment, even if these texts are not strictly aligned by domain experts to the proficiency standard.

Some embodiments may employ other generalizations of the Rasch or IRT model, also known as a “one parameter” or “1PL” IRT model, such as 2PL, 3PL, or 4PL models to incorporate parameters for item-level discrimination, guess-ability, or slippage in addition to difficulty. Embodiments may also use IRT models that use alternative item response functions such as continuous item response functions or item response functions that accommodate mixtures of continuous and discrete responses. As with the item difficulty parameter, these item parameters may be deconstructed and represented by an Item Parameter Feature Function (IPFF). Embodiments of the disclosure may implement these generalizations and are fully compatible with other lRT frameworks or representations as well.

In one embodiment, the disclosed IRT model uses a 2-parameter logistic response function. It has two parameters, each of which may be represented as a weighted-sum of features (or other form of IPFF). To adapt the disclosed IRT model to other forms of IRT models, one would replace the 2-parameter logistic response function with the appropriate item response function for that model. The function's test item parameters would be deconstructed in the same manner as disclosed herein for item difficulty and discrimination.

In some embodiments, the disclosed approach enumerates exam sessions {1, . . . S}, and test items {1, . . . N}, where S and N denote the number of sessions and number of items, respectively. In the traditional Rasch model (a 1-parameter logistic IRT model), the probability of a test-taker in exam session i∈{1, . . . S} correctly responding to item j∈{1, . . . N} is modeled as an item response function (IRF) of the form:

p(Yᵢⱼ=1; Θ)=σ(αᵢ−βⱼ)=exp(αᵢ−βⱼ)/(1+exp(αᵢ−βⱼ)),

where a parameter Θ=(α,β) is an element of R^{i+j} and represents the proficiency of each test-taker and the difficulty of each test item, respectively. Note that the symbol “σ” is used to represent the sigmoid function. As can be understood from the formula, the more proficient the student (i.e., the higher their skill level or ability), the higher the probability of a correct response, From another perspective, the model suggests that the greater a test taker's “proficiency” is relative to the difficulty of an item or task, the better the test taker is expected to perform (as indicated by the probability (p) approaching a normalized value of 1).

In some embodiments, to model test-taker response data, the Rasch or standard IRT model may be generalized (extended) into a linear logistic test model (LLTM) by deconstructing the item difficulty, βⱼ, into multiple features. Each feature may be represented by a function (ϕₖ) with a corresponding weight (ωₖ). Note that though this example embodiment represents the overall task or item difficulty as a weighted combination of item features , other forms of combining the individual features may be used, as disclosed herein. Based on the assumed form of the test item or task difficulty, the equation or formula is extended to model the probability of the user in exam session i responding correctly to item j as:

p(Yᵢⱼ=1; Θ)=σ(αᵢ−Σ[ωₖ.ϕₖ(j)]),

where the sum is over k=1 to K (meaning a total of K features are considered), the parameter =(α,ω) is an element of R^{i+K}, and the approach uses K feature functions ϕ to extract features of an item. For example, ϕₖ may represent features of linguistic complexity, word frequency, and/or topical relevance for embodiments in a language assessment setting. In LLTMs, these item features are typically interpreted as “skills” associated with responding to the item, but the log-linear formulation allows for arbitrary numerical features to be incorporated (e.g., textual embeddings such as BERT, or other domain-relevant indexes).

In some embodiments, skills may be represented as item features by using Boolean (0/1) indicators to denote whether a skill is required or not required for a given item. The disclosed model also supports arbitrary numeric values. In this context, the feature functions that extract features may be a user-defined “function” that can be computed on an item, such as an expert-labeled response to “does this item require understanding the past participle”, which would be a binary function (and similar to a “skill” as defined above). Feature functions may instead be something of the form “what is the length of the longest clause in this sentence” with a whole number value response, or “what is the ratio of pronouns to non-pronouns” which would have a fractional result. Further, the feature functions may be automatically extracted values and have no specific, individual human-understandable interpretation, such as those produced by BERT or another form of language processing.

As an example of domain or subject matter expert annotations, the Common European Framework of Reference for Language (CEFR; Council of Europe, 2001) defines guidelines for the language proficiency of non-native language learners. Its six levels of proficiency are (from lowest to highest) A1, A2, B1, B2, C1, and C2. Unlike with some traditional classification tasks, the set of CEFR categories are ordered, so the disclosed model can treat predicting an item or passage's CEFR level (z) as an ordinal regression problem. This enables an embodiment of the disclosed approach to model a CEFR level prediction task (i.e., inference of the CEFR level corresponding to a test item) in a generalized linear model by learning a set of cutpoints (level boundaries) that divide the logit scale representing item difficulty among the CEFR levels. In the scenario described, the CEFR labels are being used as an auxiliary prediction task in the disclosed multi-learning framework.

In some embodiments, the disclosed approach models a discrete probability distribution of an item passage's CEFR level (or other criterion-referenced reading difficulty scale), z, using ordinal regression. To do this, the approach implements one or more of the following operations or processes:
deconstructs the item parameter representing the passage difficulty into item features on a common logit scale using an Item Parameter Feature Function (IPFF);
segments the scale on which the passage difficulties lie, referred to as the common logit scale into CEFR categories via “cutpoint” weights learned from the subject-matter expert CEFR annotations; and
transforms an item parameter representing a passage's difficulty into the (log-) probability of each CEFR level using the learned cutpoints.

The transformation step (logit into a (log-) probability) requires the inverse of a “link” function. For linear regression, this is the identity function, and for logistic and SoftMax regression it is the logit function. For the ordinal regression case, the disclosed approach uses what has alternatively been referred to as the proportional odds, cumulative logit, or logistic cumulative link. This describes a function that transforms the model's internal result (the logit) into the desired output scale (for example, a value between 0 and 1).

Applying this form of link function, results in defining the probability of level (z) as:

$$\begin{matrix} & σ ( {ξ}_{1} ) & z = 1 \\ P ( {Z}_{j} = z ; λ ) = & σ ( {ξ}_{z} ) - σ ( {ξ}_{z - 1} ) & 1 < z < C \\ & 1 - σ ( {ξ}_{C - 1} ) & z = C\end{matrix}$$

where the approach relies on a sorted vector λ of C−1 cutpoints to divide the logit scale representing difficulty into C levels according to ξ_{z} and σ represents the sigmoid function. An item's most likely category, z, is determined from the logit scale by which cutpoints it falls between. For example, for language tests using a proficiency scale such as the CEFR levels, there will be a cutpoint on the underlying logit line that separates CEFR level A1 from CEFR level A2, and another similarly separating CEFR level A2 from CEFR level B1. Any item whose difficulty parameter on the logit scale is in between these two cutpoints would be predicted to be CEFR level A2.

As described, in the case that item difficulties are modeled as a linear combination of item features, the approach computes the item or passage difficulty as βⱼ=Σ[ωₖ.ϕₖ(j)], where the sum is from k=1 to K (where K is the number of features). The formula, βj=Σ[ωk.ϕk(j)], is an example of an Item Parameter Feature Function (IPFF). A machine learning model is trained to jointly learn (i.e., predict or infer) the passage-based item difficulty and the CEFR level cutpoints that contextualize them. As a result, the model can directly generate a value representing a test-taker's proficiency or an item's difficulty in terms of its CEFR level. This is because the model represents both the passage's ordinal CEFR level and the test-taker's proficiency on a common (logit) scale. The probability computation therefore depends on a vector, w, of weights that govern the (relative) contribution of each item feature to the overall difficulty of the task. The weights are shared between the two prediction tasks (test taker test item response and CEFR level assigned to test item by subject-matter expert), so feature weights learned from the CEFR level prediction task can refine the item parameter estimates for the other task.

Because the trained model “learns” to predict test taker responses and the CEFR label using the same weighted combination of input features, the learned weighted combination can be aligned to both the CEFR scale and to an IRT difficulty scale, the latter of which can also be used to represent test taker ability. The disclosed approach relates CEFR level to a common scale by representing CEFR levels as a segmentation of the logit scale. This enables the expression of CEFR level, item difficulty, and test-taker proficiency on a common scale. Although the common scale is continuous, and CEFR is a discrete ordinal classification, the CEFR classes are aligned to the continuous scale, thereby allowing use of CEFR labels to better estimate item difficulties and to allow an interpretation of test taker abilities in terms of the CEFR scale.

For item featurization (to identify an item's features and generate the functions (ϕₖ)), an embodiment may use a text embedding representation such as the Bidirectional Encoder Representations from Transformers (BERT), which can implicitly represent linguistic content of input text. For k an element of [1, 2, . . . 768], let ϕₖ(j) be defined as BERT(text(j))ₖ, where the “text” function extracts the section of text for item j and the BERT function extracts the 768-dimensional embedding of the classification token (CLS) from the BERT network's output. In this sense, BERT computes a vector to represent a section of input text. In one embodiment, the disclosed approach “tunes” the parameters of a joint model Θ=(α, λ, ω) by maximum a posteriori (MAP) estimation to better predict both test taker success on a test item based on a section of text, and the section's CEFR level, where a may be used to represent the test-taker proficiency estimates. As described, the approach uses a common logit scale segmented into CEFR levels to enable both the computation and a more effective comparison of a test-taker's ability and the CEFR level of a test item (which is indicative of the skill or ability expected to be needed to properly respond to the test item).

Embodiments of the disclosed approach or methodology may implement one or more of the following steps or stages to produce a trained model that combines supervised learning of criterion-referenced item level (which uses expert-labeled annotation data to train the model) and item response theory (which uses observational response data of test takers to train the model). This allows the model to refine or interpret item parameter estimates by incorporating test-taker response data.

In some embodiments, this may be accomplished by implementing one or more of the following steps, stages, processes, operations, or functions:
Model the probability of a test-taker i, responding correctly to a test item j, as an explanatory IRT model, where the explanatory IRT model incorporates Item Parameter Feature Functions (IPFF) to represent test item parameters in a form that is based on the test item features;
Model a discrete conditional probability distribution of a test-item's CEFR level (or another criterion-referenced ordered set of levels or indicators of relative aptitude expected to be needed to respond correctly to the test item);
   a the discrete probability distribution over CEFR levels is conditioned on the test item feature values describing the item's content;
   each item's “difficulty” is deconstructed into features, and that difficulty can be used to derive the test item's CEFR level probability distribution;
Train a machine learning (ML) model to “learn” the test-taker proficiencies and the Item Parameter Feature Function weights to jointly predict or infer ordinal CEFR annotations and whether a test-taker item response will be correct;
   the part of the ML model that predicts test-taker item responses is an IRT model, and that part of the model estimates test-taker proficiencies during the model training process;
   as an example, an input to the trained model could be in the form of linguistic features for a prompt of a particular test item, and the outputs would represent (1) the probability that a given user will correctly respond, and (2) the test item's corresponding CEFR level;
The shared logit scale that maps both test items and students/test-takers onto a shared linear projection, can be interpreted as both:
   Criterion-referenced (construct-based expert annotations); and
   Norm-referenced (observational IRT-based item difficulties or student abilities);
Given such a trained model, new test items can have their parameters estimated and be mapped into this same projection based on their item features (e.g., BERT embeddings or other form of representation) without the need for expert annotation or extensive human pilot testing;
   A benefit of the disclosed approach is that this can expedite the process of adding new items to a test. It may also be used to filter large banks of candidate items by selecting items with desired parameters (e.g., high discrimination) prior to piloting or adding those items to an operational test;
By administering lessons or assessments (tests) that are composed of items projected in this way, traditional IRT-based inference techniques may be used to place the student or test-taker on the projected scale;
   This allows inferences regarding both the criterion-referenced construct (e.g.,

CEFR) as well as relative norm-referenced test-taker ability, because the latent output scale for the multi-task model is jointly learned; that is, each norm-referenced difficulty estimate (or test-taker ability estimate) has a corresponding criterion-referenced CEFR level as well.

In some embodiments, individual words within a passage that a test-taker must respond to may be modeled as individual items, For example, each damaged (altered) word within a c-test (a question format used to measure language proficiency) passage may be modeled as an individual item whose parameters are estimated in terms of its features using Item Parameter Feature Functions (IPFF). In such cases, word-level features, such as contextual word embeddings extracted via BERT models, may be used.

In some embodiments, multilingual language embeddings may be used as features to generalize estimates of item parameters across tests with test items in different languages. For example, if one has a large set of item responses to c-test items written in English, such an embodiment could be used to estimate the item parameters of c-test items written in Spanish, French, or other language supported by a multilingual embedding model.

In some embodiments, learnable item-level residual parameters that adjust the feature-based item parameter estimates for individual items may be included in a model. In such embodiments, the residual parameters allow the parameter estimates of a test item to be refined, independent of the item's features, as more test-taker response data is collected for that item. Such residual parameters may use Gaussian priors or other regularization method to avoid adjusting the parameter estimates too much until sufficient test-taker responses data is collected.

In some embodiments, an IRT model with item parameters deconstructed into features via an Item Parameter Feature Function (IPFF) may be treated as a generalized non-linear mixed effects model (GNLMM). In such cases, the model parameters (such as IPFF weights and test-taker proficiency estimates) may be estimated using statistical methods germane to those kinds of models,

In some embodiments, fixed proxy estimates for test-taker proficiencies may be used when estimating item parameters as deconstructions of item features. Such proxy estimates may be derived from performance on items other than those whose parameters are being estimated by the model. In such cases, the proxy estimates may be used in place of the test-taker proficiencies that would normally be estimated jointly with the item Parameter Feature Function (IPFF) weights. Alternatively, one may employ a Bayesian approach by using the proxy estimates as means for Gaussian priors on the test-taker proficiency estimates when estimating them jointly with item parameters.

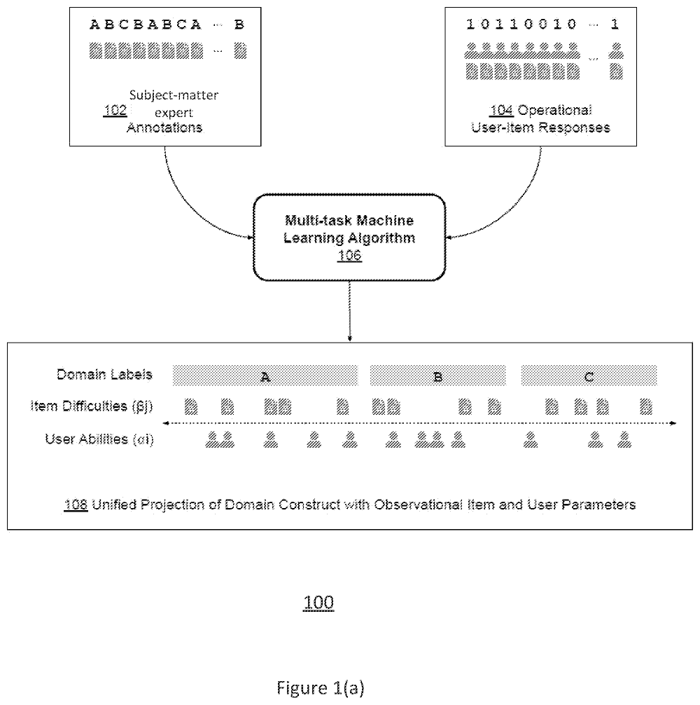

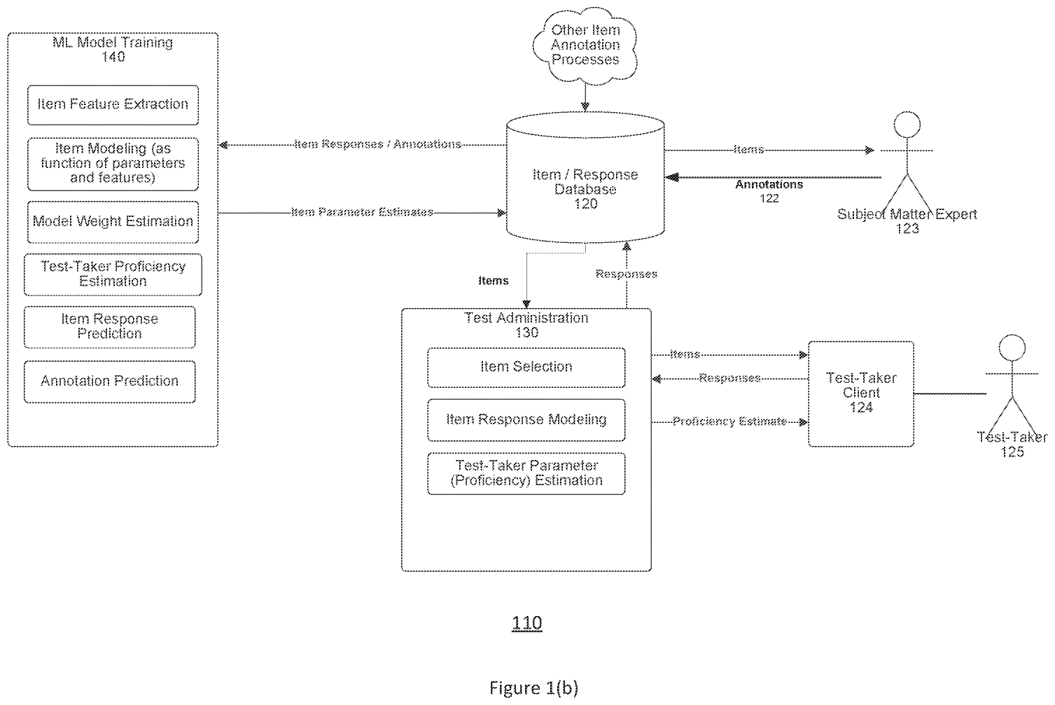

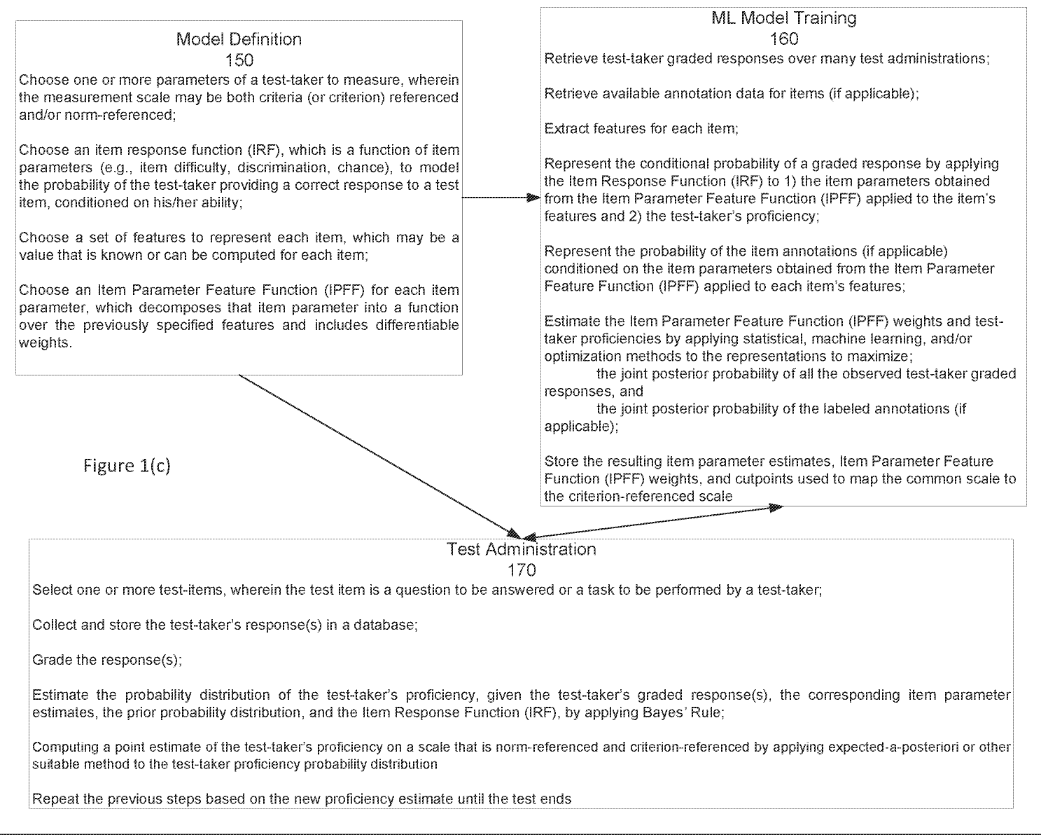

FIG. 1(a) is a diagram illustrating elements or components and processes that may be incorporated in a system to perform Educational and Psychological Modeling and Assessment, in accordance with some embodiments. As shown in the figure, a system 100 may comprise two sources of data used to train a multi-task machine learning model. A first source of data 102 comprises subject-matter expert annotations of test items (suggested by items A, B, C, . . . in the figure). The annotations reference an ordered scale representing the expert's evaluation of the level of the test item (or content of comparable form, such as a passage of text for language assessments) in terms of the degree of language proficiency required to comprehend the test item and respond to it correctly. A second source of data 104 comprises test-taker responses to the same test items and an indication of whether that response was correct or not (as suggested by the notation of either “1” or “0” associated with each item).

Both sets of data are provided as inputs to a mufti-task machine learning algorithm 106 which is used to generate a trained model, Given appropriate features (e.g., BERT ernbeddings or other linguistic indexes, in the case of language testing embodiments), the output of the trained model may be represented as a projection 108 combining the level annotations (as defined by a framework or rubric, such as the CEFR) with test-taker proficiency a and item difficulty βj (both of which are inferred from operational test administration data) along the same ordered scale. In one sense, the output of the trained model represents how a test-taker's response relates to a value in a set of ordered indications of competency.

FIG. 1(b) is a diagram illustrating a set of processes, operations, functions, elements, or components that may be part of a system used to implement an embodiment. As shown in the figure, a system 110 may comprise one or more of the following:
a test item and test taker response database 120;
a set of data 122 provided by subject matter experts 123 (e.g., annotations indicating the expert's assessment of the level of skill needed to answer a test item correctly, and in some embodiments expressed as a CEFR level);
a test taker client 124 used by a test-taker 125 to access test items, provide a response, and receive an estimate of their proficiency (typically expressed using the same scale as used by the subject matter expert or a scale that can be interpreted in relation to it);
a test administration server 130, configured to perform functions that may include:
   a test item selection;
   a test item response modeling; and
   a test-taker proficiency estimation; and
a machine learning (ML) model training function 140, configured to perform functions that may include:
   a test item feature extraction (computing one or more features of a test item);
   test item modeling (modeling a test item's response probability distribution conditioned on the test taker's proficiency and the item parameters, the latter of which are calculated in terms of item features);
   model weight estimation;
   test-taker parameter estimation (such as test-taker proficiency);
   test item response prediction (i.e., whether a test-taker's response will be correct for a test item); and
   annotation prediction (the expected assessment by a domain or subject expert of the level of skill needed to answer a test item correctly).

FIG. 1(c) is a diagram illustrating the primary processes, operations, or functions performed as part of implementing an embodiment. As shown in the figure, an embodiment may comprise a Model Definition phase 150, a ML Model Training phase 160, and a Test Administration phase 170, with each configured to perform one or more of the indicated processes, operations, or functions.

As non-limiting examples, Model Definition phase 150 may comprise processes, functions, or operations including:
Choosing (selecting or identifying) one or more ability parameters of a test-taker to measure, wherein the scale may be both criteria (or criterion) referenced and/or norm-referenced;
Choosing an item response function (IRF), which is a function of test item parameters (e.g., item difficulty, discrimination, or chance), to model the probability of the test-taker providing a correct response to a test item, conditioned on (dependent upon) his/her ability and the item's parameters;
Choosing a set of features to represent each test item, each of which may be a value that is known or can be computed (extracted) for an item; and
Choosing an Item Parameter Feature Function (IPFF) for each test item parameter, which deconstructs that item parameter into a function dependent on the previously specified features and includes one or more differentiable weights.

As non-limiting examples, Machine Learning Model Training phase 160 may comprise processes, functions, or operations including:
Retrieving test-taker graded responses from multiple test administrations;
Retrieving available annotation data for test items (such as subject matter expert indications of the expected level of proficiency needed to correctly answer a test item, if available and applicable);
Extracting one or more features for each test item (such as from a language embedding model);
Representing the conditional probability of a particular graded response by applying the Item Response Function (IRF) to (1) the item parameters obtained from the Item Parameter Feature Function (IPFF) applied (evaluated) to the item's features and (2) the test-taker's proficiency (level of skill or ability);
   In one sense, this represents the probability that the test taker will respond with a correct answer (e.g., there is an 80% chance he/she will get it right) given the test-taker's proficiency and the item's parameters;
Estimating the Item Parameter Feature Function (IPFF) weights and test-taker proficiencies (the level of skill) by applying statistical, machine learning, and/or optimization methods to the representations to maximize;
   the joint posterior probability of all the observed test-taker graded responses, and
   the joint posterior probability of the labeled annotations (if applicable);
      in one sense, this serves to optimize Item Parameter Feature Function (IPFF) weights to jointly predict a test-taker response to a test item and a subject-matter expert's evaluation of the test item difficulty; and
Storing the resulting item parameter estimates, Item Parameter Feature Function (IPFF) weights, and cutpoints used to map the common scale to the criterion-reference scale (e.g., CEFR this can be used to interpret a test-taker's proficiency estimate after they take a test) in a memory or data storage element.

As non-limiting examples, the Test Administration phase 170 may comprise processes, functions, or operations including:
Selecting one or more test-items, wherein the test item is a question to be answered or a task to be performed by a test-taker;
   If a test-taker proficiency estimate is available, then the items may be selected adaptively by using the item parameters to evaluate which items will be most informative about the test-taker's proficiency;
Collecting and storing a test-taker's response(s) in a database;
Grading the response(s) to indicate correct or incorrect responses;
Estimating the probability distribution of the test-taker's proficiency, given the test-taker's graded response(s), the corresponding item parameter estimates, the prior probability distribution, and the Item Response Function (IRF);
   This may be done by applying Bayes' Rule or another suitable technique;
Computing a point estimate of the test-taker's proficiency from the probability distribution, by applying expected-a-posteriori or other suitable method; and
Repeating the previous steps based on the new proficiency estimate until the testing process is completed;
   In one use case, the disclosed approach may be used to more effectively and accurately determine a test taker's proficiency at a task.

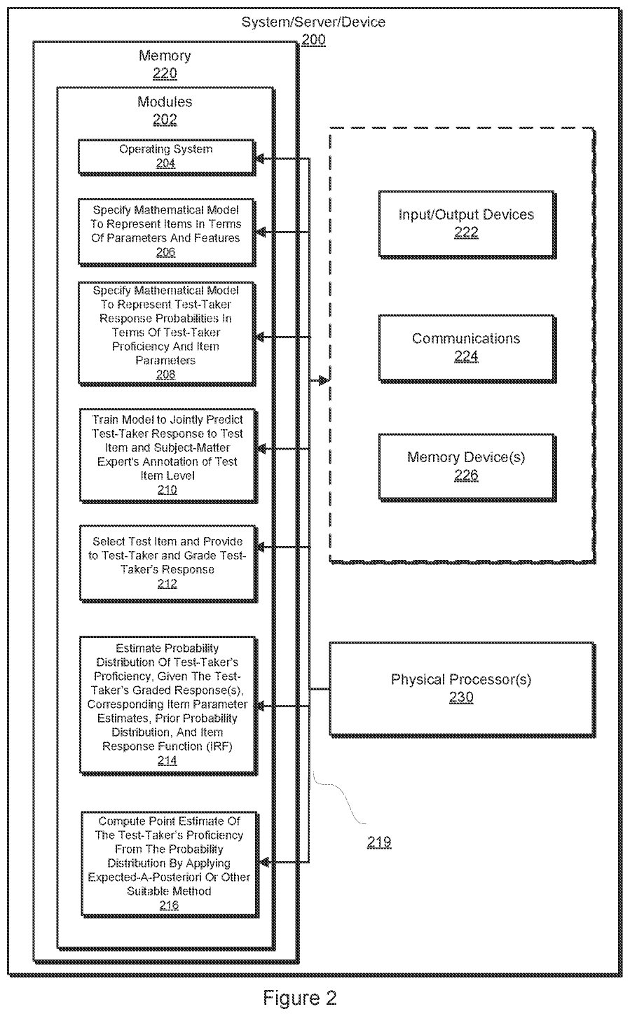

FIG. 2 is a diagram illustrating elements or components that may be present in a computing device or system configured to implement a method, process, function, or operation in accordance with an embodiment of the system and methods disclosed herein. As shown in the figure and as mentioned, in some embodiments, the system and methods may be implemented in the form of an apparatus that includes a processing element and set of executable instructions. The executable instructions may be stored in (or on) a memory or data storage element and be part of a software application arranged into a software architecture.

In general, an embodiment may be implemented using a set of software instructions that are designed to be executed by a suitably programmed processing element (such as a GPU, CPU, TPU, CPU, state machine, microprocessor, processor, co-processor, or controller, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or submodule may correspond to a particular function, method, process, or operation that is implemented by the module or submodule. Such function, method, process, or operation may include those used to implement one or more aspects of the described systems and methods.

The application modules and/or submodules may include a suitable computer-executable code or set of instructions (e.g., as would be executed by a suitably programmed processor, microprocessor, co-processor, or CPU, as examples), such as computer-executable code corresponding to a programming language. For example, programming language source code may be compiled into computer-executable code. Alternatively, or in addition, the programming language may be an interpreted programming language such as a scripting language.

Modules may contain one or more sets of instructions for performing a method or function described with reference to the Figures, and the descriptions or disclosure of the functions and operations provided in the specification. These modules may include those illustrated but may also include a greater number or fewer number than those illustrated. As mentioned, each module may contain a set of computer-executable instructions. The set of instructions may be executed by a programmed processor contained in a server, client device, network element, system, platform, or other component.

A module may contain instructions that are executed by a processor contained in more than one of a server, client device, network element, system, platform or other component. Thus, in some embodiments, a plurality of electronic processors, with each being part of a separate device, server, or system may be responsible for executing all or a portion of the software instructions contained in an illustrated module. Thus, although FIG. 2 illustrates a set of modules which taken together perform multiple functions or operations, these functions or operations may be performed by different devices or system elements, with certain of the modules (or instructions contained in those modules) being associated with those devices or system elements.

As shown in FIG. 2, system 200 may represent a server or other form of computing or data processing system, platform, or device. Modules 202 each contain a set of executable instructions, where when the set of instructions is executed by a suitable electronic processor or processors (such as that indicated in the figure by “Physical Processor(s) 230”), system (or server, platform, or device) 200 operates to perform a specific process, operation, function, or method. Modules 202 are stored in a memory 220, which typically includes an Operating System module 204 that contains instructions used (among other functions) to access and control the execution of the instructions contained in other modules. The modules 202 stored in memory 220 are accessed for purposes of transferring data and executing instructions by use of a “bus” or communications line 219, which also serves to permit processor(s) 230 to communicate with the modules for purposes of accessing and executing a set of instructions. Bus or communications line 219 also permits processor(s) 230 to interact with other elements of system 200, such as input or output devices 222, communications elements 224 for exchanging data and information with devices external to system 200, and additional memory devices 226.

In some embodiments, the modules may comprise computer-executable software instructions that when executed by one or more electronic processors or co-processors cause the processors or co-processors (or a system or apparatus containing the processors or co-processors) to perform one or more of the steps or stages of:
Specifying (or receiving a user's specification of) a mathematical model to represent items in terms of parameters and features (as suggested by module 206);
Specifying (or receiving a user's specification of) a mathematical model to represent test-taker response probabilities in terms of test-taker proficiency and item parameters (as suggested by module 208);
Training a Model to Jointly Predict Test-Taker Response to Test Item and Subject-Matter Expert's Evaluation of Test Item Level (as suggested by module 210);
Selecting a test Item and providing the item to the test-taker and grading the test-taker's response (as suggested by module 212);
Estimating the probability distribution of the test-taker's proficiency, given the test-taker's graded response(s), corresponding item parameter estimates, prior probability distribution, and Item Response Function (IRF) (as suggested by module 214); and
Computing a point estimate of the test-taker's proficiency from the probability distribution by applying expected-a-posteriori or other suitable method (as suggested by module 216).

In some embodiments, the trained machine learning model may be used to evaluate a user's proficiency or skill level based on the user's response(s) to an item or set of items and the relative difficulty of those items. This approach may also be used as part of a decision regarding the contents of an item, the expected performance of a set of users when asked to respond to an item, and the performance of a user compared to others asked to respond to the different items.

In addition to the specific use case or application described herein (evaluating the proficiency of a test-taker), embodiments of the approach and methodology described herein may be used in the one or more of the following contexts:
Testing across languages. For example, expert annotations and operational student responses from an English test might be combined in the multi-task framework with expert annotations for Spanish, French, or Chinese (as examples). This can be used to “jump-start” language assessments in other languages using multilingual (or language-agnostic) representations for items, such as Multilingual BERT (M-BERT);
Personalized instruction. For example, homework or other exercises (items) may be completed by students. Models trained with the multi-task machine learning framework can predict the likelihood that a student will get a particular exercise correct, which can in turn be used to deliver personalized, adaptive homework assignments for a given domain range (not too easy, not too difficult, but just right to encourage a student);
Aligning curricula from different subjects. For example, the subject-matter expert annotations might be K-12 grade levels, where educators have annotated classroom exercises (items) from Mathematics, Language Arts, or Social Studies, accordingly, Operational student responses can be combined with these annotations in the multi-task framework to better align subject matter empirically; or
Non-educational applications of Psychometrics. For example, measuring attitudes, personality traits, or clinical constructs of mental disorders. Domain experts may annotate questionnaire items, symptom scales, or other item instruments and combine these theory-based annotations with empirical subject responses using the disclosed multi-task framework.

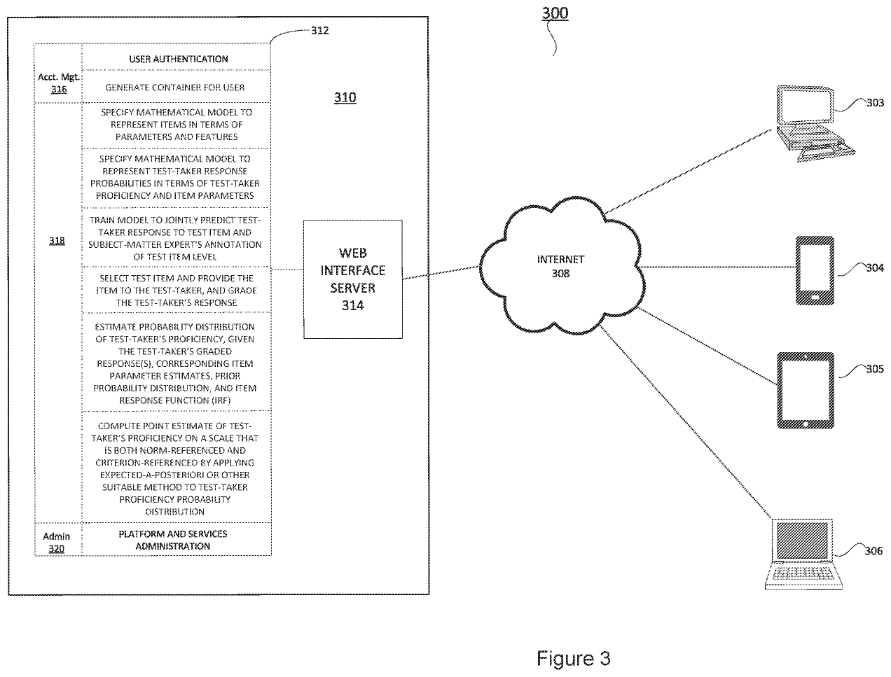

In some embodiments, the functionality and services provided by the system and methods described herein may be made available to multiple users by accessing an account maintained by a server or service platform. Such a server or service platform may be termed a form of Software-as-a-Service (SaaS). FIGS. 3-5 are diagrams illustrating a deployment of the system and methods described herein for Educational and Psychological Modeling and Assessment as a service or application provided through a Software-as-a-Service platform, in accordance with some embodiments.

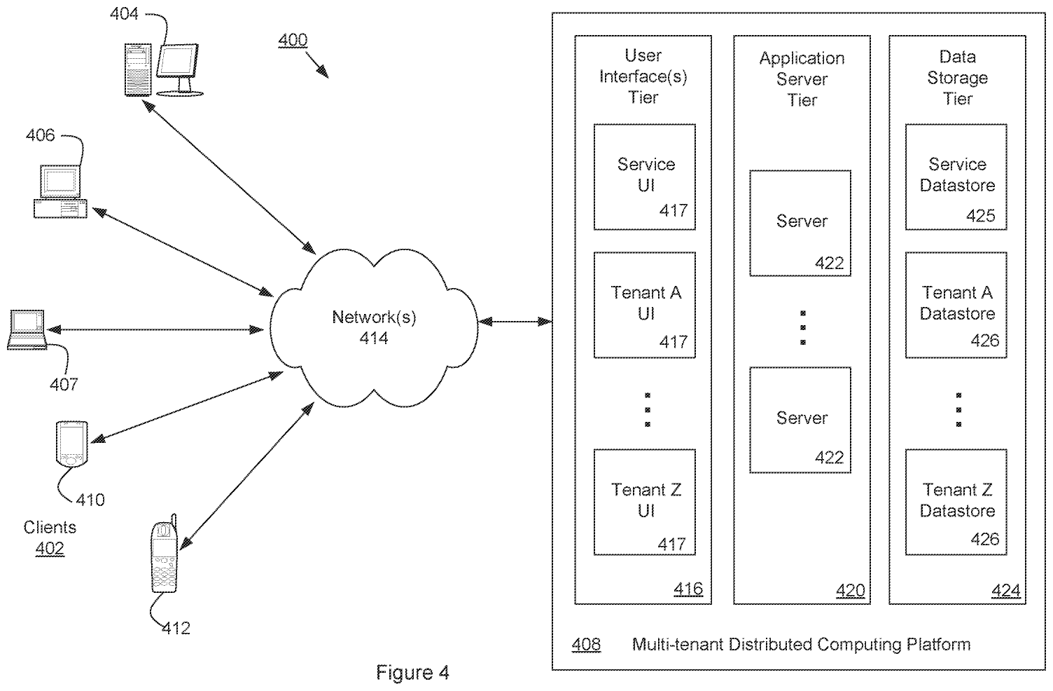

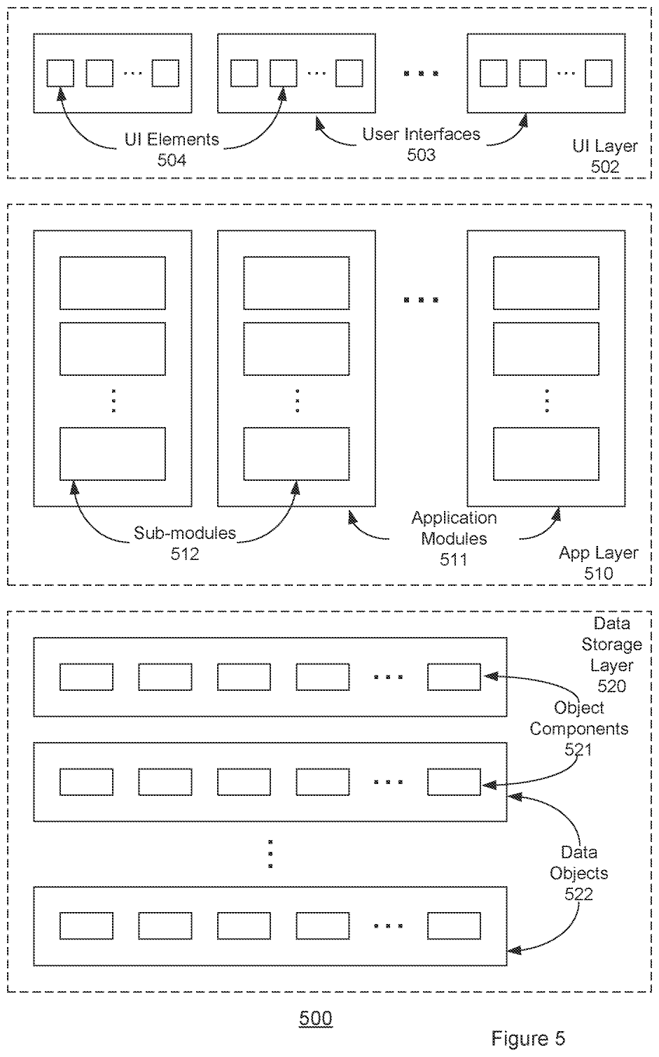

FIG. 3 is a diagram illustrating a SaaS system in which an embodiment of the disclosure may be implemented. FIG. 4 is a diagram illustrating elements or components of an example operating environment in which an embodiment of the disclosure may be implemented. FIG. 5 is a diagram illustrating additional details of the elements or components of the multi-tenant distributed computing service platform of FIG. 4, in which an embodiment of the disclosure may be implemented.

In some embodiments, the system or service(s) described herein may be implemented as micro--services, processes, workflows, or functions performed in response to a user request. The micro-services, processes, workflows, or functions may be performed by a server, data processing element, platform, or system. In some embodiments, the services may be provided by a service platform located “in the cloud”. In such embodiments, the platform is accessible through APIs and SDKs. The described model development and test-taker evaluation processing and services may be provided as micro-services within the platform for each of multiple users or companies. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts users, such an architecture may also be used to deliver other types of data processing services and provide access to other applications, For example, such an architecture may be used to provide the data processing, model training, and test-taker evaluation methodology described herein.

Although in some embodiments, a platform or system of the type illustrated in FIGS. 3-5 may be operated by a 3^{rd} party provider to provide a specific set of business-related applications, in other embodiments, the platform may be operated by a provider and a different business may provide the applications or services for users through the platform. For example, some of the functions and services described with reference to FIGS. 3-5 may be provided by a 3^{rd} party with the provider of the trained models maintaining an account on the platform for each company or business using a trained model to provide services to that company's customers.

FIG. 3 is a diagram illustrating a system 300 in which an embodiment of the disclosure may be implemented or through which an embodiment of the services described herein may be accessed. In accordance with the advantages of an application service provider (ASP) hosted business service system (such as a multi-tenant data processing platform), users of the services described herein may comprise individuals, businesses, stores, organizations, etc. A user may access the services using any suitable client, including but not limited to desktop computers, laptop computers, tablet computers, scanners, srnartphones, etc. In general, any client device having access to the Internet may be used to provide a request or text message requesting customer support services and to receive and display an intent tree model. Users interface with the service platform across the Internet 308 or another suitable communications network or combination of networks. Examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. It is to be appreciated that either or both services 312 and web interface server 314 may be implemented on one or more different hardware systems and components, even though represented as singular units in FIG. 3. Services 312 may include one or more functions or operations for the processing of test item data, processing user responses, generating representations of test item difficulty, representing the difficulty associated with each of a set of proficiency levels, the construction of a trained model as described herein, or using the trained model to evaluate the proficiency of a test-taker in terms of the levels, as non-limiting examples.

In some embodiments, the set of services or applications available to a company or user may include one or more that perform the functions and methods described herein with reference to the enclosed figures. As examples, in some embodiments, the set of applications, functions, operations or services made available through the platform or system 310 may include:
account management services 316, such as
   a process or service to authenticate a person wishing to access the services/applications available through the platform (such as credentials, proof of purchase, or verification that the customer has been authorized by a company to use the services);
   a process or service to generate a container or instantiation of the services, methodology, applications, functions, and operations described, where the instantiation may be customized for a particular company; and
   other forms of account management services;
a set 318 of data processing services, applications, or functionality, such as a process or service for
   Specifying (or receiving a user's specification of) a mathematical model to represent items in terms of parameters and features;
   Specifying (or receiving a user's specification of) a mathematical model to represent test-taker response probabilities in terms of test-taker proficiency and item parameters;
   Training a model to jointly predict test-taker responses to test items and subject-matter expert's annotations of test item levels;
   Selecting a test Item and providing the item to the test-taker, and grading the test-taker's response;
   Estimating the probability distribution of the test-taker's proficiency, given the test-taker's graded response(s), corresponding item parameter estimates, prior probability distribution, and Item Response Function (IRF); and
   Computing a point estimate of the test-taker's proficiency on a scale that is both norm-referenced and criterion-referenced by applying expected-a-posteriori or other suitable method to the test-taker proficiency probability distribution; and
administrative services 320, such as
   a process or services to enable the provider of the data processing or test-taker evaluation services and/or the platform to administer and configure the processes and services provided to users.

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

FIG. 4 is a diagram illustrating elements or components of an example operating environment 400 in which an embodiment of the disclosure may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented at least in part by one or more of the computing devices. Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc.

Each application server 422 or processing tier 420 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity in order to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the data processing and model training described herein) are provided to users, with each company/business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment of the disclosure may be implemented. The software architecture shown in FIG. 5 represents an example of an architecture which may be used to implement an embodiment of the invention. In general, an embodiment of the invention may be implemented using a set of software instructions that are designed to be executed by a suitably programmed processing element (such as a CPU, GPU, microprocessor, processor, co-processor, or controller, as non-limiting examples). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment of the disclosure may be implemented. The example architecture includes a user interface layer or tier 502 having one or more user interfaces 503. Examples of such user interfaces include graphical user interfaces and application programming interfaces (APIs), Each user interface may include one or more user interface (UI) elements 504.

For example, users may interact with user interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more submodules 512. Each application module 511 or submodule 512 may correspond to a function, method, process, or operation that is implemented by the module or submodule (e.g., a function or process related to providing data processing and services to a user of the platform). Such function, method, process, or operation may include those used to implement one or more aspects of the inventive system and methods, such as for one or more of the processes or functions disclosed herein and described with reference to the Figures:
Specifying (or receiving a user's specification of) a mathematical model to represent items in terms of parameters and features;
Specifying (or receiving a user's specification of) a mathematical model to represent test-taker response probabilities in terms of test-taker proficiency and item parameters;
Training a model to jointly predict test-taker responses to test items and subject-matter expert's annotations of test item levels;
Selecting a test Item and providing the item to the test-taker, and grading the test-taker's response;
Estimating the probability distribution of the test-taker's proficiency, given the test-taker's graded response(s), corresponding item parameter estimates, prior probability distribution, and Item Response Function (IRE); and
Computing a point estimate of the test-taker's proficiency on a scale that is both norm-referenced and criterion-referenced by applying expected-a-posteriori or other suitable method to the test-taker proficiency probability distribution,

The application modules and/or submodules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

This disclosure includes the following embodiments or clauses:

1. A method of estimating one or more test item parameters for an item response theory model used to evaluate a person's performance on a set of test items, comprising:
specifying an item response function to represent a probability of a given graded response to each of a plurality of test items conditioned on one or more test item parameters expressed in terms of one or more test item features;
specifying a common scale between the one or more item parameters and an annotated property of each of the plurality of test items; and
training a predictive model to jointly predict a test-taker's responses to each of the plurality of test items and a subject-matter expert's annotation of each of the test items.

2. The method of clause 1, further comprising:
providing one or more of the plurality of test items to a test-taker;
grading the test-taker's response to each of the provided test items;
estimating a probability distribution of the test-taker's proficiency, given the test-taker's graded responses, the item response function, and corresponding test item parameter estimates, and
based on the estimated probability distribution, evaluating the test-taker's performance on the test items using the resulting proficiency probability distribution or a point estimate derived from it using maximum-a-posteriori, expected-a-posteriori, or other suitable method.

3. The method of clause 2, wherein the test items are used in a language proficiency test.

4. The method of clause 2, wherein each of the plurality of test items after a first test item is selected based on the test-takers proficiency estimated derived from the test-taker's graded responses to the previously provided items.

5. The method of clause 1, wherein the subject-matter expert's annotation of the test item is a criterion-referenced level of test-taker proficiency needed to correctly answer the test item and the common scale is both criteria-referenced and norm-referenced.

6. The method of clause 5, wherein the criterion-referenced level is Common

European Framework of Reference for Languages (CEFR).

7. The method of clause 1, wherein the test item parameters comprise one or more of test item difficulty, test item discrimination, or chance,

8. The method of clause 1, wherein one or more of the test item features are derived from a language embedding model.

9. A method of estimating one or more test item parameters for an item response theory model used to evaluate a person's performance on a set of test items, comprising:
specifying an item response function to represent the probability of a given response to each of a plurality of test items conditioned on one or more test item parameters expressed in terms of one or more test item features;
expressing the one or more test item features as a language embedding produced by a language embedding model; and
training a predictive model to jointly predict a test-taker's responses to each of the plurality of test items and a subject-matter expert's annotation of each of the test items.

10. The method of clause 9, wherein the test item features are expressed as multilingual language embeddings.

11. The method of clause 9, wherein the test item parameters comprise one or more of test item difficulty, test item discrimination, or chance.

12. The method of clause 9, wherein the test items are c-test items.

13. A system for estimating one or more test item parameters for an item response theory model used to evaluate a person's performance on a set of test items, comprising:
a non-transitory computer-readable medium including a set of computer-executable instructions;
one or more electronic processors configured to execute the set of computer-executable instructions, wherein when executed, the instructions cause the one or more electronic processors to
   specify an item response function to represent the probability of a given graded response to each of a plurality of test items conditioned on one or more test item parameters expressed in terms of one or more test item features;
   specify a common scale between the one or more item parameters and an annotated property of each of the plurality of test items; and
   train a predictive model to jointly predict each of a plurality of test-taker responses to each of the plurality of test items and a subject-matter expert's annotation of the test item.

14. The system of clause 13, wherein the computer-executable instructions further comprise instructions that cause the one or more electronic processors to:
provide one or more of the plurality of test items to a test-taker;
grade the test-taker's response to each of the provided test items;
estimate a probability distribution of the test-taker's proficiency, given the test-taker's graded responses and corresponding test item parameter estimates, and
based on the estimated probability distribution, evaluate the test-taker's performance on the test items using the resulting proficiency probability distribution or a point estimate derived from it using maximum-a-posteriori, expected-a-posteriori, or other suitable method.

15. The system of clause 13, wherein the subject-matter expert's annotation of the test item is a criterion-referenced level of test-taker proficiency needed to correctly answer the test item and the common scale is both criteria-referenced and norm-referenced.

16. The system of clause 15, wherein the criterion-referenced level is Common European Framework of Reference for Languages (CEFR).

17. The system of clause 13, wherein the test item parameters comprise one or more of test item difficulty, test item discrimination, or chance,

18. The system of clause 13, wherein one or more of the test item features are derived from a language embedding model.

19. The system of clause 13, wherein the test items are used in a language proficiency test.

20. The system of clause 14, wherein each of the plurality of test items after a first test item is selected based on the test-takers proficiency estimated derived from the test-taker's graded responses to the previously provided items.

Embodiments of the disclosure may be implemented in the form of control logic using computer software in a modular or integrated manner. Based on the disclosure and teachings provided herein, a person of ordinary skill in the art will recognize other ways and/or methods to implement an embodiment using hardware, software, or a combination of hardware and software.

In some embodiments, certain of the methods, models, processes, or functions disclosed herein may be embodied in the form of a trained neural network or other form of model derived from a machine learning algorithm. The neural network or model may be implemented by the execution of a set of computer-executable instructions and/or represented as a data structure. The instructions may be stored in (or on) a non-transitory computer-readable medium and executed by a programmed processor or processing element. The set of instructions may be conveyed to a user through a transfer of instructions or an application that executes a set of instructions over a network (e.g., the Internet). The set of instructions or an application may be utilized by an end-user through access to a SaaS platform, self-hosted software, on-premise software, or a service provided through a remote platform.

In general terms, a neural network may be viewed as a system of interconnected artificial “neurons” or nodes that exchange messages between each other. The connections have numeric weights that are “tuned” during a training process, so that a properly trained network will respond correctly when presented with an image, pattern, or set of data. In this characterization, the network consists of multiple layers of feature-detecting “neurons”, where each layer has neurons that respond to different combinations of inputs from the previous layers.

Training of a network is performed using a “labeled” dataset of inputs in an assortment of representative input patterns (or datasets) that are associated with their intended output response. Training uses general-purpose methods to iteratively determine the weights for intermediate and final feature neurons. In terms of a computational model, each neuron calculates the dot product of inputs and weights, adds a bias, and applies a non-linear trigger or activation function (for example, using a sigmoid response function).

Machine learning (ML) is used to analyze data and assist in making decisions in multiple industries. To benefit from using machine learning, a machine learning algorithm is applied to a set of training data and labels to generate a “model” which represents what the application of the algorithm has “learned” from the training data. Each element (or example) in the form of one or more parameters, variables, characteristics, or “features” of the set of training data is associated with a label or annotation that defines how the element should be classified by the trained model. A machine learning model can predict or infer an outcome based on the training data and labels and be used as part of decision process. When trained, the model will operate on a new element of input data to generate the correct label or classification as an output.

Any of the software components, processes or functions described in this application may be implemented as software code to be executed by a processor using any suitable computer language such as Python, Java, JavaScript, C++, or Perl using procedural, functional, object-oriented, or other techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a srnartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, may be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that may direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims,

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted, Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein may be performed in any suitable order unless otherwise indicated herein or clearly contradicted by context. The use of all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

What is claimed is:

1. A method of estimating one or more test item parameters for an item response theory model used to evaluate a person's performance on a set of test items, comprising:
specifying an item response function to represent a probability of a given graded response to each of a plurality of test items conditioned on one or more test item parameters expressed in terms of one or more test item features;
specifying a common scale between the one or more item parameters and an annotated property of each of the plurality of test items; and
training a predictive model to jointly predict a test-taker's responses to each of the plurality of test items and a subject-matter expert's annotation of each of the test items.

2. The method of claim 1, further comprising:
providing one or more of the plurality of test items to a test-taker;
grading the test-taker's response to each of the provided test items;
estimating a probability distribution of the test-taker's proficiency, given the test-taker's graded responses, the item response function, and corresponding test item parameter estimates, and
based on the estimated probability distribution, evaluating the test-taker's performance on the test items using the resulting proficiency probability distribution or a point estimate derived from it using maximum-a-posteriori, expected-a-posteriori, or other suitable method.

3. The method in claim 2, wherein the test items are used in a language proficiency test.

4. The method of claim 2, wherein each of the plurality of test items after a first test item is selected based on the test-takers proficiency estimated derived from the test-taker's graded responses to the previously provided items.

5. The method of claim 1, wherein the subject-matter expert's annotation of the test item is a criterion-referenced level of test-taker proficiency needed to correctly answer the test item and the common scale is both criteria-referenced and norm-referenced.

6. The method of claim 5, wherein the criterion-referenced level is Common European Framework of Reference for Languages (CEFR).

7. The method of claim 1, wherein the test item parameters comprise one or more of test item difficulty, test item discrimination, or chance,

8. The method of claim 1, wherein one or more of the test item features are derived from a language embedding model.

9. A method of estimating one or more test item parameters for an item response theory model used to evaluate a person's performance on a set of test items, comprising:
specifying an item response function to represent the probability of a given response to each of a plurality of test items conditioned on one or more test item parameters expressed in terms of one or more test item features;
expressing the one or more test item features as a language embedding produced by a language embedding model; and
training a predictive model to jointly predict a test-taker's responses to each of the plurality of test items and a subject-matter expert's annotation of each of the test items.

10. The method of claim 9, wherein the test item features are expressed as multilingual language embeddings.

11. The method of claim 9, wherein the test item parameters comprise one or more of test item difficulty, test item discrimination, or chance.

12. The method of claim 9, wherein the test items are c-test items.

13. A system for estimating one or more test item parameters for an item response theory model used to evaluate a person's performance on a set of test items, comprising:
a non-transitory computer-readable medium including a set of computer-executable instructions;
one or more electronic processors configured to execute the set of computer-executable instructions, wherein when executed, the instructions cause the one or more electronic processors to
specify an item response function to represent the probability of a given graded response to each of a plurality of test items conditioned on one or more test item parameters expressed in terms of one or more test item features;
specify a common scale between the one or more item parameters and an annotated property of each of the plurality of test items; and
train a predictive model to jointly predict each of a plurality of test-taker responses to each of the plurality of test items and a subject-matter expert's annotation of the test item.

14. The system of claim 13, wherein the computer-executable instructions further comprise instructions that cause the one or more electronic processors to:
provide one or more of the plurality of test items to a test-taker;
grade the test-taker's response to each of the provided test items;
estimate a probability distribution of the test-taker's proficiency, given the test-taker's graded responses and corresponding test item parameter estimates, and
based on the estimated probability distribution, evaluate the test-taker's performance on the test items using the resulting proficiency probability distribution or a point estimate derived from it using maximum-a-posteriori, expected-a-posteriori, or other suitable method,

15. The system of claim 13, wherein the subject-matter expert's annotation of the test item is a criterion-referenced level of test-taker proficiency needed to correctly answer the test item and the common scale is both criteria-referenced and norm-referenced.

16. The system of claim 15, wherein the criterion-referenced level is Common European Framework of Reference for Languages (CEFR).

17. The system of claim 13, wherein the test item parameters comprise one or more of test item difficulty, test item discrimination, or chance.

18. The system of claim 13, wherein one or more of the test item features are derived from a language embedding model.

19. The system of claim 13, wherein the test items are used in a language proficiency test.

20. The system of clause 14, wherein each of the plurality of test items after a first test item is selected based on the test-takers proficiency estimated derived from the test-taker's graded responses to the previously provided items.
